(19) United States
(12) Patent Application Publication
(10) Pub. No.: US 2019/0205089 A1
(43) Pub. Date: Jul. 4, 2019

(54) SERVER DEVICE, INFORMATION PROCESSING TERMINAL, SYSTEM, AND METHOD

(71) Applicant: SHARP KABUSHIKI KAISHA, Sakai City, Osaka (JP)

(72) Inventor: AKIRA WATANABE, Sakai City, Osaka (JP)

(21) Appl. No.: 16/331,096

(22) PCT Filed: Feb. 16, 2017
(86) PCT No.: PCT/JP2017/005687

§ 371 Date: Mar. 6, 2019

(30) Foreign Application Priority Data
Sep. 29, 2016 (JP) 2016-191218

(51) Int. Cl. G06F 3/16

(52) U.S. Cl. CPC G06F 3/165

(57) ABSTRACT

A server device includes a communication interface, a storage device, and a control device. The storage device stores a state history of an information processing terminal capable of outputting sound. The state history is acquired through the communication interface. The control device is configured to determine a music parameter based on the state history and transmit music generated based on the determined music parameter to the information processing terminal through the communication interface.

### TECHNICAL FIELD

The present disclosure relates to a technique of controlling a terminal capable of reproducing music, and more specifically to a technique for determining a parameter for generating music. The subject application claims the priority based on Japanese Patent Application No. 2016-191218 filed with the Japan Patent Office on Sep. 29, 2016, the entire contents of which are hereby incorporated by reference.

### BACKGROUND ART

Automatic music composition using calculation means such as computers have recently received attention. Applications for such automatic composition basically do not compose music from nothing but compose music by combining the huge number of melodies and rhythms for generating music in accordance with an instruction (indicator) from users.

In relation to automatic composition techniques, Japanese Patent Laying-Open No. 2015-079130 (PTL 1) discloses a musical sound information generating apparatus in which when lyrics are input and a parameter is specified, musical sound information at least including pitch is generated for each of a plurality of morphemes that constitute the input lyrics, and a plurality of pieces of musical sound information generated corresponding to the lyrics are collectively corrected based on the specified parameter (see “Abstract”).

Japanese Patent Laying-Open No. 2007-334685 (PTL 2) discloses a content retrieval device that extracts a keyword from a keyword association list related to music preferences of an agent character selected by a user and retrieves music of an attribute suitable for the music preferences of the agent character from a database using the extracted keyword (see “Abstract”).

### CITATION LIST

### Patent Literature

PTL 1: Japanese Patent Laying-Open No. 2015-079130

PTL 2: Japanese Patent Laying-Open No. 2007-334685

### SUMMARY OF INVENTION

### Technical Problem

Unfortunately, since the technique disclosed in PTL 1 is a technique for generating music according to the user's choice (preference), the generated pieces of music are similar to each other. The user then may become bored with the generated music.

The technique disclosed in PTL 2 selects a piece of music from among a plurality of pieces of music sounds (contents) according to the user's preference and is not intended to generate music.

The present disclosure is made in order to solve the problems as described above, and an object in an aspect is to provide a technique of generating music that is less likely to bore users.

### Solution to Problem

A server device according to an embodiment includes a communication interface, a storage device, and a control device. The storage device stores a state history of an information processing terminal capable of outputting sound. The state history is acquired through the communication interface. The control device is configured to determine a music parameter based on the state history and transmit music generated based on the determined music parameter to the information processing terminal through the communication interface.

### Advantageous Effects of Invention

The server device according to an embodiment can generate a plurality of pieces of music that are not similar to each other. This server device thus can prevent users from being bored with the generated music.

The foregoing and other objects, features, aspects, and advantages of the present invention will become apparent from the following detailed description pertaining to the present invention understood in conjunction with the accompanying drawings.

### BRIEF DESCRIPTION OF DRAWINGS

FIG. 1 is a diagram illustrating the control of music generation according to an embodiment.

FIG. 2 is a diagram illustrating a configuration example of a control system according to an embodiment.

FIG. 3 is a diagram illustrating a hardware configuration example of a terminal and a server according to an embodiment.

FIG. 4 is a diagram illustrating a hardware configuration of the server according to another embodiment.

FIG. 5 is a diagram illustrating an event history table according to an embodiment.

FIG. 6 is a diagram illustrating a method of updating an event history table according to an embodiment.

FIG. 7 is a diagram illustrating a parameter determination table according to an embodiment.

FIG. 8 is a diagram illustrating the control of determining a music parameter according to an embodiment.

FIG. 9 is a flowchart illustrating the control for generating music according to an embodiment.

FIG. 10 is a diagram illustrating the control system according to an embodiment in another aspect.

FIG. 11 is a diagram illustrating a configuration of a terminal and a server according to an embodiment.

FIG. 12 is a diagram illustrating a device management DB according to an embodiment.

FIG. 13 is a diagram illustrating a type parameter table according to an embodiment.

FIG. 14 is a diagram illustrating the control of determining a music parameter based on a history music parameter and a type parameter according to an embodiment.

FIG. 15 is a diagram illustrating a user parameter table according to an embodiment.

FIG. 16 is a flowchart illustrating the control in the server for generating music according to an embodiment.

FIG. 17 is a diagram illustrating a configuration example of a terminal according to an embodiment.

FIG. 18 is a flowchart illustrating the control of generating music in the terminal according to an embodiment.

### DESCRIPTION OF EMBODIMENTS

Embodiments of the present invention will be described in detail below with reference to the drawings. In the following description, the same parts are denoted by the same reference signs. Their names and functions are also the same. Therefore, a detailed description thereof will not be repeated.

[Technical Concept]

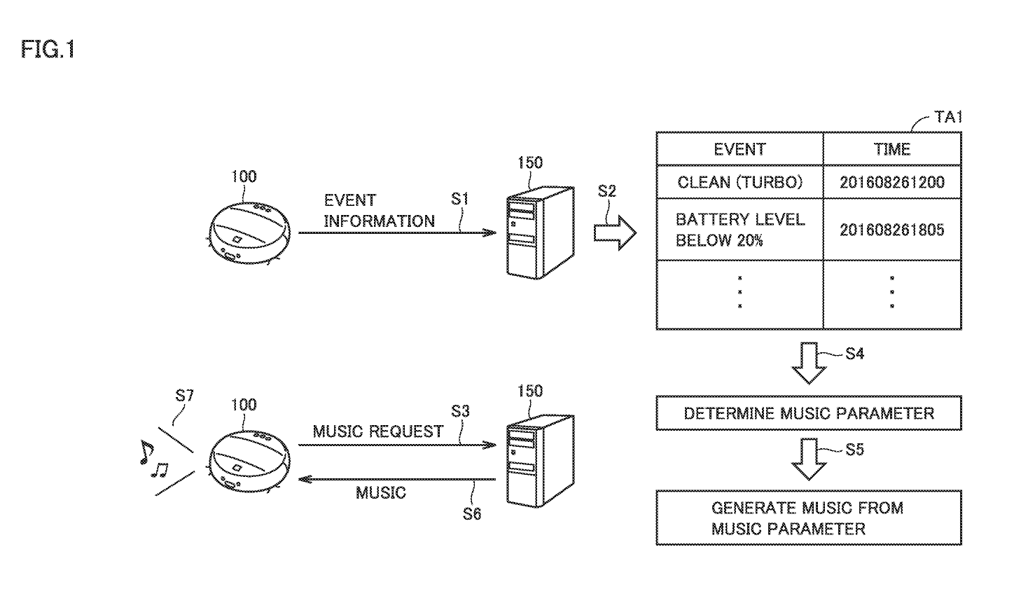

FIG. 1 is a diagram illustrating the control of music generation according to an embodiment. Referring to FIG. 1, a terminal 100 and a server 150 are configured to communicate with each other. Terminal 100 may be a terminal capable of information processing. In an embodiment, terminal 100 may be a vacuum cleaner, a microwave oven, a refrigerator, a washing machine, an air conditioner, an air cleaner, a rice cooker, a television, a smartphone, a tablet, a personal computer, and any other home appliances. In the example shown in FIG. 1, terminal 100 is a vacuum cleaner.

In an embodiment, server 150 is configured to generate music in accordance with a music parameter. The “music parameter” refers to a parameter necessary for generating music in an application capable of generating music.

At step S1, when a preset event (for example, cleaning operation, running out of charge, etc.) occurs, terminal 100 transmits event information indicating as such to server 150.

At step S2, server 150 stores the received event information in a history table TA1 in a storage device described later. History table TA1 holds an event of terminal 100 and a time associated with each other. Server 150 thus has the history of terminal 100.

At step S3, terminal 100 transmits a music request to generate music to server 150.

At step S4, in response to receiving the music request, server 150 determines a music parameter, based on history table TA1, that is, the history of terminal 100.

At step S5, server 150 generates music based on the determined music parameter. At step S6, server 150 transmits the generated music (music data) to terminal 100. At step S7, terminal 100 reproduces (outputs) the received music from a sound output device such as a speaker.

According to the foregoing, server 150 according to an embodiment generates music based on the history of terminal 100. The history of terminal 100 is updated as appropriate with time. Therefore, a plurality of pieces of music generated by server 150 tend to vary according to the history of terminal 100 of the moment. This server device thus can prevent the user from being bored with the generated music.

The user may have a plurality of terminals capable of communicating with a server capable of generating music. If the server simply generates music according to the user's preference, the pieces of music reproduced in those terminals are similar to each other. The user then may become bored with the generated music.

However, server 150 according to an embodiment generates music based on the history of each terminal. In general, a user use terminals in different manners depending on the types of terminals (for example, a vacuum cleaner and a refrigerator). Therefore, the generated pieces of music may tend to be different from each other. Server 150 according to an embodiment thus can prevent the user from being bored with the generated music even when the user has a plurality of terminals 100. A method of determining a music parameter will be specifically described below.

### First Embodiment-Determination of Music Parameter Based on History

(Control System)

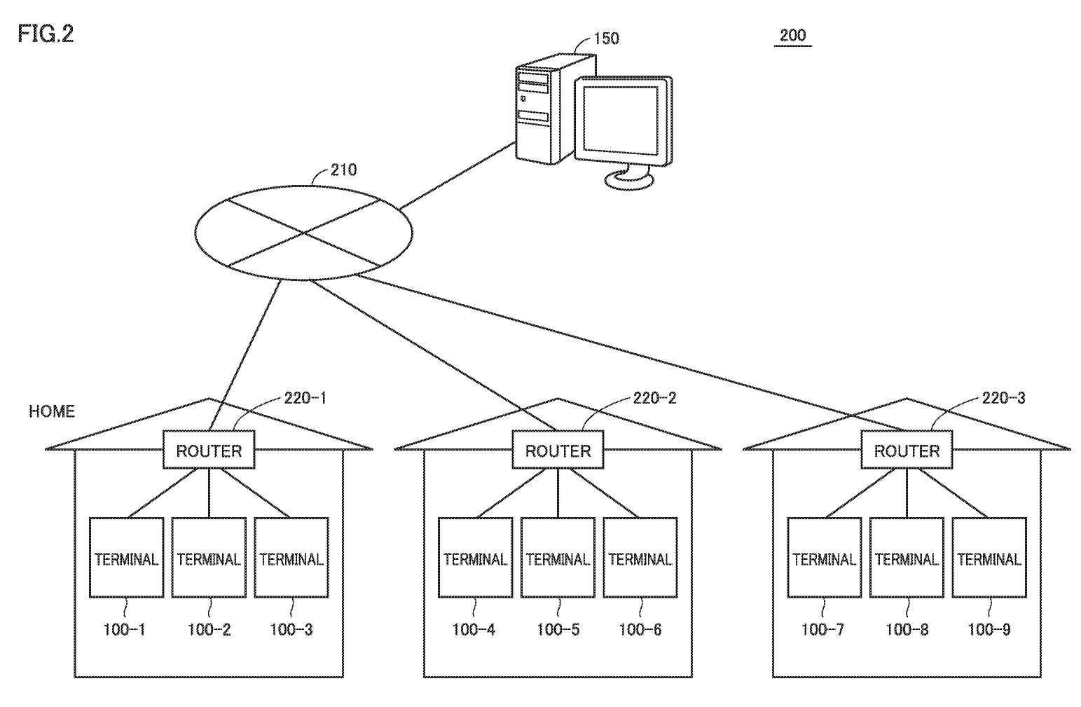

FIG. 2 is a diagram illustrating a configuration example of a control system 200 according to an embodiment. Referring to FIG. 2, control system 200 includes server 150, routers 220-1 to 220-3, and terminals 100-1 to 100-9. Hereinafter, routers 220-1 to 220-3 may be collectively referred to as “router 220”. Terminals 100-1 to 100-9 may be collectively referred to as “terminal 100”.

Terminals 100-1 to 100-3 are each connected to router 220-1. Terminals 100-4 to 100-6 are each connected to router 220-2. Terminals 100-7 to 100-9 are each connected to router 220-3. Terminal 100 and router 220 are connected by wire or by radio.

Server 150 is connected to router 220 through a network 210. Terminal 100 is indirectly connected to server 150.

In the configuration in the example shown in FIG. 2, three terminals 100 are connected to each router 220. However, the number of terminals 100 connected to router 220 is not limited to three. The number of terminals 100 connected to router 220 can be changed as long as router 220 can allocate local IP (Internet Protocol) addresses.

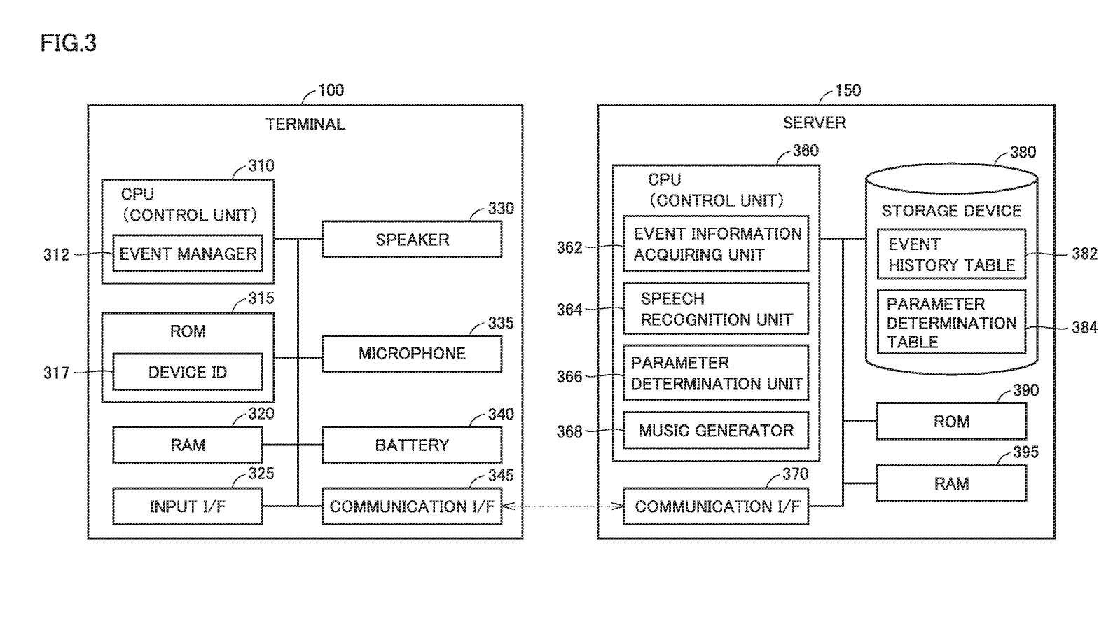

FIG. 3 is a hardware configuration example of terminal 100 and server 150 according to an embodiment.

(Hardware Configuration of Terminal)

Terminal 100 includes a CPU (Central Processor Unit) 310, a ROM (Read Only Memory) 315, a RAM (Random Access Memory) 320, an input I/F 325, a speaker 330, a microphone 335, a battery 340, and a communication I/F 345.

CPU 310 functions as a control unit that controls the operation of terminal 100. In an aspect, CPU 310 can function as an event manager 312 by reading and executing a control program stored in ROM 315.

Event manager 312 detects that a preset event occurs in terminal 100 and transmits event information indicating as such to server 150.

ROM 315 may store a control program to be executed by CPU 310 and a device ID 317 for identifying each of a plurality of terminals 100. In an aspect, device ID 317 may be an MAC (Media Access Control) address of terminal 100 (communication I/F 345).

RAM 320 functions as a working memory for temporarily storing data necessary for CPU 310 to execute the control program.

Input I/F 325 is an interface for accepting a user's input. In an aspect, input I/F 325 may be an infrared receiver accepting an input from a not-shown infrared remote controller. In another aspect, input I/F 325 may be a button provided on terminal 100. In yet another aspect, input I/F 325 may be a touch panel provided on terminal 100.

Speaker 330 converts audio information into sound and outputs the sound. In another aspect, terminal 100 may include headphones, earphones, and any other sound output devices in place of speaker 330 or in addition to speaker 330.

Microphone 335 converts sound around terminal 100 into audio information as an electrical signal and outputs the audio information to CPU 310.

Battery 340 is typically a lithium ion secondary battery and functions as a device for supplying electric power to each device included in terminal 100.

Communication I/F 345 communicates with communication I/F 370 of server 150 described later and exchanges a variety of signals.

(Hardware Configuration of Server)

Server 150 may include a CPU 360, a communication I/F 370, a storage device 380, a ROM 390, and a RAM 395.

CPU 360 functions as a control unit that controls the operation of server 150. In an aspect, CPU 360 may function as an event information acquiring unit 362, a speech recognition unit 364, a parameter determination unit 366, and a music generator 368 by reading and executing a control program stored in storage device 380 or ROM 390.

Event information acquiring unit 362 updates an event history table 382 described later, based on event information received from terminal 100.

Speech recognition unit 364 performs speech recognition processing for audio information received from terminal 100. Speech recognition unit 364 thus extracts a character string from audio information.

Parameter determination unit 366 determines a music parameter necessary for music generator 368 to generate music.

Music generator 368 generates music based on the music parameter determined by parameter determination unit 366. Music generator 368 may be implemented by a known application. In an aspect, music generator 368 may be implemented using VOCALODUCER (registered trademark) provided by Yamaha Corporation.

Communication I/F 370 is an interface for communicating with terminal 100 and may be a wireless LAN (Local Area Network) card, by way of example. Server 150 is configured to communicate with terminal 100 connected to a LAN or a WAN (Wide Area Network) through communication I/F 370.

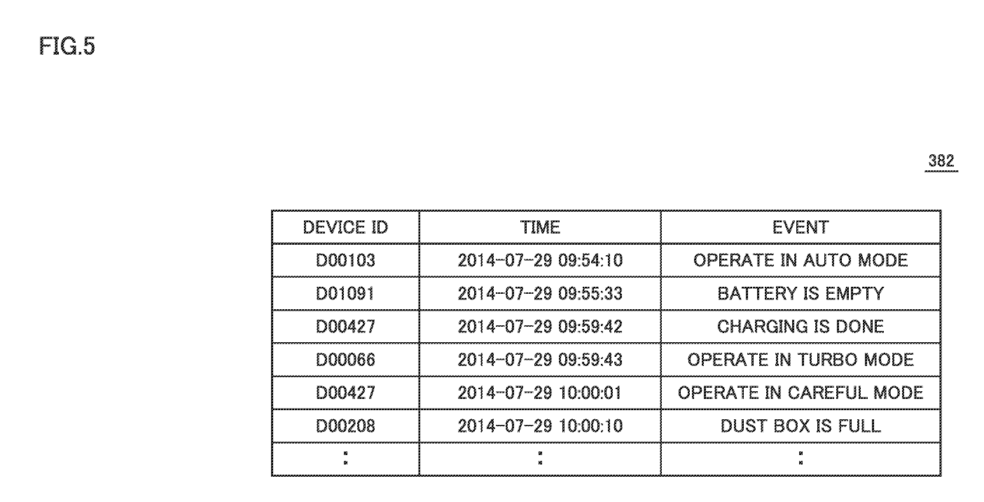

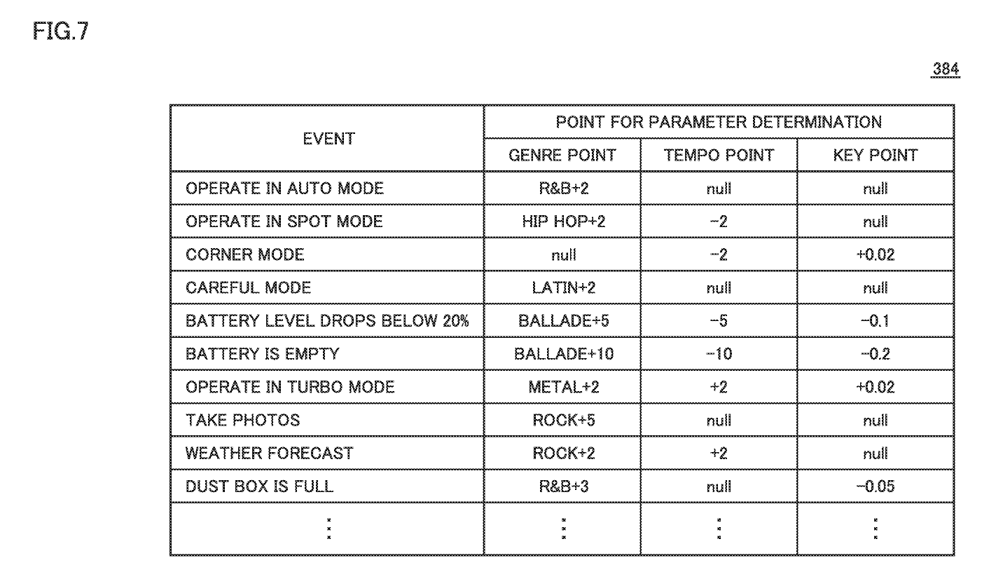

Storage device 380 is typically, for example, a hard disk drive and stores an event history table 382 and a parameter determination table 384. Event history table 382 holds the history of terminal 100. Parameter determination table 384 holds points necessary for determining a music parameter. The detail of these tables will be described later with reference to FIG. 5 and FIG. 7.

ROM 390 is typically, for example, a flash memory and may store a control program to be executed by CPU 360 and a variety of setting information related to the operation of server 150.

RAM 395 is typically, for example, a DRAM (Dynamic Random Access Memory) and functions as a working memory for temporarily storing data necessary for CPU 360 to execute the control program.

In another aspect, CPU 360 of server 150 may not have the functional configuration of the music generator.

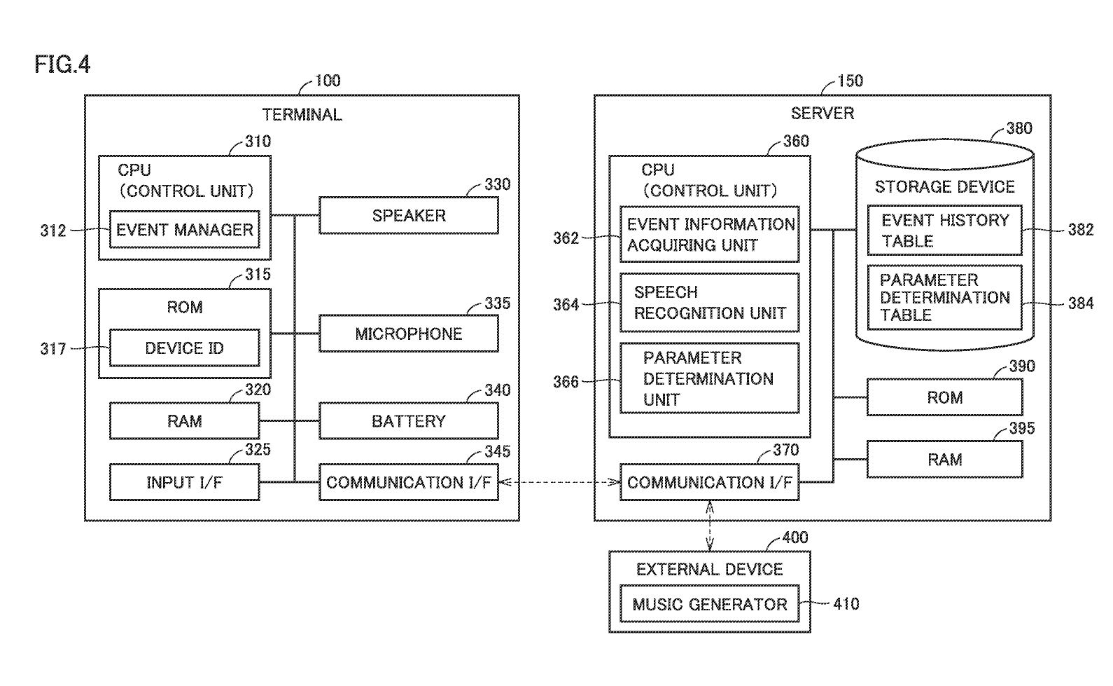

FIG. 4 is a diagram illustrating a hardware configuration of server 150 according to another embodiment. In another embodiment, CPU 360 of server 150 does not have a music generator as its functional configuration.

In this case, server 150 according to another embodiment may communicate with an external device 400 having a music generator 410 for generating music based on a music parameter.

More specifically, server 150 transmits the music parameter determined by parameter determination unit 366 to external device 400. External device 400 is configured to generate music by music generator 410 based on the received music parameter and transmit the generated music to server 150. The control system may have such a configuration. In yet another aspect, external device 400 may be configured to transmit the generated music directly to terminal 100 rather than to server 150.

In the examples shown in FIGS. 3 and 4, server 150 includes one CPU 360, one communication I/F 370, and one storage device 380. However, in another aspect, the server may have a plurality of each of these devices. For example, the server may have two or more CPUs to perform the process described later in a distributed manner. The server may have two or more communication I/Fs to transmit/receive information to/from terminal 100. The server may communicate with terminal 100 through a first communication I/F and communicate with external device 400 through a second communication I/F. The server may have two or more storage devices so that data to be stored is stored in the storage devices in a distributed manner.

(Event History Table)

FIG. 5 is a diagram illustrating event history table 382 according to an embodiment.

Referring to FIG. 5, event history table 382 holds a device ID, a time, and an event associated with each other. In the example shown in FIG. 5, terminal 100 is a vacuum cleaner.

In the example shown in FIG. 5, in terminal 100 with device ID “D00103”, an event “operate in auto mode” occurs at time “2014-07-29 09:54:10”.

In terminal 100 with device ID “D01091”, an event “the battery is empty” occurs at time “2014-07-29 09:55:33”.

In terminal 100 with device ID “D00427”, an event “charging is done” occurs at time “2014-07-29 09:59:42”.

In terminal 100 with device ID “D00066”, an event “operate in turbo mode” occurs at time “2014-07-29 09:59:43”.

In terminal 100 with device ID “D00427”, an event “operate in careful mode” occurs at time “2014-07-29 10:00:01”.

In terminal 100 with device ID “D00208”, an event “the dust box is full” occurs at time “2014-07-29 10:00:10”.

As described above, event history table 382 holds events that have occurred and times, for each terminal 100.

The events may include a state event indicating a state of terminal 100, such as “the battery is empty”, in addition to an operation event indicating the operation of terminal 100, such as “operate in turbo mode”. In this manner, the event history table stores the state history of terminal 100. The “state history” includes a history indicating the operation of terminal 100 and a history indicating the state of terminal 100.

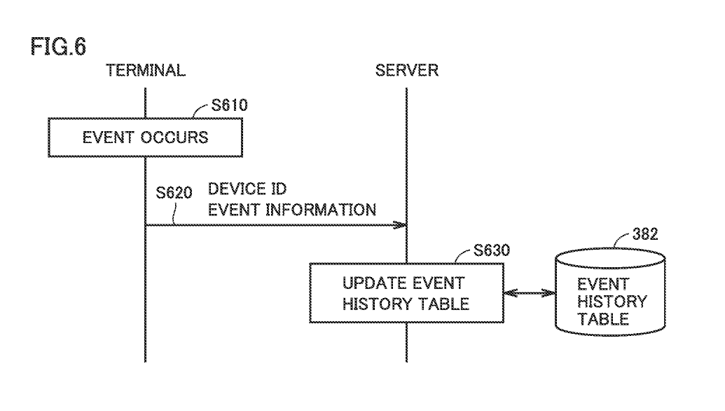

FIG. 6 is a diagram illustrating a method of updating event history table 382 according to an embodiment. The process shown in FIG. 6 is implemented by CPU 110 and CPU 360 executing the control programs stored in the respective storage devices.

At step S610, CPU 310 of terminal 100 serves as event manager 312 and detects occurrence of a preset event.

At step S620, CPU 310 transmits event information indicating information of the detected event and device ID 317 stored in ROM 315 to server 150.

At step S630, CPU 360 of server 150 serves as event information acquiring unit 362 and adds the event information and device ID 317 received from terminal 100 and the time of reception to event history table 382 in association with each other.

In another aspect, event manager 312 may transmit the time when the event occurs, together with the event information and device ID 317, to server 150. In this case, event information acquiring unit 362 may add the time when the event occurs, together with the event information and device ID 317, to event history table 382.

In yet another aspect, event information acquiring unit 362 may be configured to hold the event information only for a predetermined period of time (for example, 90 days). In this case, event information acquiring unit 362 may delete the event information after lapse of a predetermined period of time from event history table 382.

(Parameter Determination Table)

FIG. 7 is a diagram illustrating parameter determination table 384 according to an embodiment.

Referring to FIG. 5, parameter determination table 384 holds an event, a genre point, a tempo point, and a key point associated with each other.

In an embodiment, the music parameter includes a genre parameter, a tempo parameter, and a key parameter.

The “genre parameter” is a parameter for determining one of a plurality of genres stored in storage device 380. In other words, the “genre parameter” is a parameter for determining a genre of music to be generated by music generator 368. In an aspect, seven genres, namely, “hip hop”, “Latin”, “ballad”, “metal”, “country”, “rock”, and “R&B (Rhythm and blues)” are stored in storage device 380.

The “tempo parameter” is a parameter for determining a tempo (for example, BPM: Beats Per Minute) of music to be generated by music generator 368. In an aspect, the tempo parameter may be set from 80 bpm to 160 bpm.

The “key parameter” is a parameter for changing a reference key determined by the genre parameter in music generator 368. In other words, the key parameter is a parameter for determining a key of music to be generated by music generator 368. In an aspect, the key parameter may be set to an integer from −6.0 to +6.0.

In another aspect, the music parameter may include a rhythm parameter for determining a rhythm of music, a chord parameter for determining a chord progression of music, a melody parameter for determining melody of music, and a length parameter for determining the length (time) of music.

In yet another aspect, music generator 368 may be configured to reproduce music including lyrics, and the music parameter may include information of lyrics (text data). In this case, information of lyrics may be registered by the user operating input I/F 325 or speaking to microphone 335.

The “genre point” is a value used for calculation in determining the genre parameter. The “tempo point” is a value used for calculation in determining the tempo parameter. The “key point” is a value used for calculation in determining the key parameter.

In the example shown in FIG. 7, for an event “operate in auto mode”, the genre point of R&B is set to “+2”. For this event, the tempo point and the key point are set to “null (nothing to be done)”.

For an event “operate in spot mode”, the genre point of hip hop is set to “+2”, and the tempo point is set to “−2”.

For an event “corner mode”, the tempo point is set to “−2”, and the key point is set to “+0.02”.

For an event “careful mode”, the genre point of Latin is set to “+2”. For an event “the battery level drops below 20%”, the genre point of ballad is set to “+5”, the tempo point is set to “−5”, and the key point is set to “−0.1”. In an aspect, event manager 312 may determine that this event occurs when the detection result of a voltmeter (not shown) connected to battery 340 falls below a predetermined value.

For an event “the battery is empty”, the genre point of ballad is set to “+10”, the tempo point is set to “−10”, and the key point is set to “−0.2”.

For an event “operate in turbo mode”, the genre point of metal is set to “+2”, the tempo point is set to “+2”, and the key point is set to “+0.02”.

For an event “take photos”, the genre point of rock is set to “+5”. In an aspect, terminal 100 is equipped with a camera (not shown). In an aspect, event manager 312 may determine that this event occurs when the user inputs an instruction to take photos with the camera to input I/F 325 or microphone 335.

For an event “weather forecast”, the genre point of rock is set to “+2”, and the tempo point is set to “+2”. In an aspect, event manager 312 may determine that this event occurs when the user makes an input to ask the weather to input I/F 325 or microphone 335.

For an event “the dust box is full”, the genre point of R&B is set to “+3”, and the key point is set to “−0.05”. In an aspect, terminal 100 is a vacuum cleaner and includes a not-shown dust box. In this case, event manager 312 may determine that this event occurs based on a detection result of a photo reflector disposed on the dust box.

(Method of Determining Music Parameter)

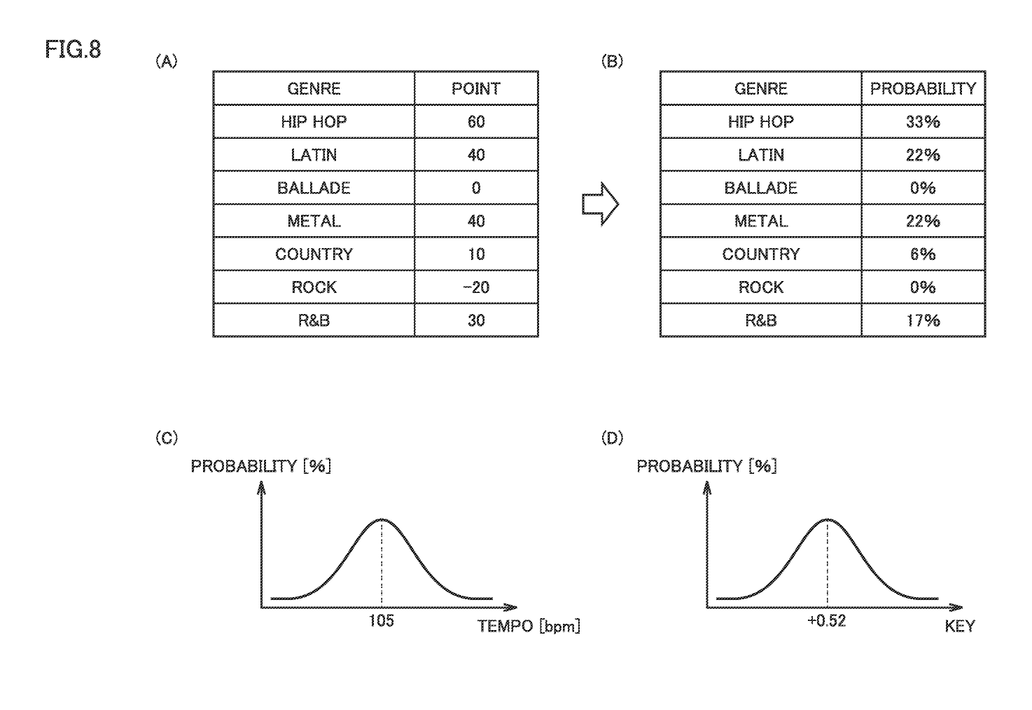

FIG. 8 is a diagram illustrating the control of determining a music parameter according to an embodiment. Server 150 accepts a music request from terminal 100 and then determines a music parameter suitable for this terminal 100.

The control for determining a genre parameter is described first.

CPU 360 of server 150 serves as parameter determination unit 366 and refers to event history table 382 to acquire the history of terminal 100 from which a music request has been accepted. More specifically, parameter determination unit 366 acquires event information corresponding to the device ID of terminal 100 from which a music request (for example, 90 days) has been accepted in a predetermined period of time, in event history table 382.

Parameter determination unit 366 then refers to parameter determination table 384 and sums up genre points corresponding to the acquired event information for each genre. The value of sum of genre points in each genre may be referred to as “genre point sum”.

As an example, it is assumed that the event “take photos” occurs twice and “the dust box is full” occurs once in a predetermined period of time. In this case, parameter determination unit 366 calculates that the genre point sum of rock is “10” and the genre point sum of R&B is “3”.

Subfigure (A) is a diagram showing a genre point sum for each genre in an aspect. In the example shown in Subfigure (A), the genre point sum of hip hop is “60”, the genre point sum of Latin is “40”, . . . the genre point sum of rock is “−20”, and the genre point sum of R&B is “30”.

Parameter determination unit 366 then calculates the ratio of the genre point sum of the genre of interest to the total of genre point sums. Here, parameter determination unit 366 may perform calculation assuming that a negative genre point sum is zero “0”. In the example in Subfigure (A), the total of genre point sums is “180”.

Subfigure (B) is a diagram showing the ratio of the genre point sum of the genre of interest to the total of genre point sums, in each genre in Subfigure (A). Using this ratio as a probability, parameter determination unit 366 determines one of seven genres as a genre parameter. In Subfigure (B), it is most probable that hip hop is selected. On the other hand, it is least probable that ballad or rock is selected.

The control for determining a tempo parameter will now be described.

Parameter determination unit 366 refers to parameter determination table 384 and sums up tempo points corresponding to the acquired event information, in the same manner as for the genre parameter. The value of the sum of tempo points may be referred to as “tempo point sum”.

As an example, it is assumed that the event “weather forecast” occurs fifty-five times and “the battery level drops below 20%” occurs once in a predetermined period of time. In this case, parameter determination unit 366 calculates that the tempo point sum is “105”.

In another aspect, an initial tempo value (for example, 120) is stored in storage device 380. In this case, parameter determination unit 366 defines the value obtained by adding the initial tempo value to the sum of tempo points corresponding to the acquired event information, as the tempo point sum.

The parameter determination unit determines a tempo parameter based on a probability distribution (for example, Gaussian distribution) with the calculated value of the tempo point sum at the center. That is, it is most probable that the value of the tempo point sum is determined as the tempo parameter.

The control for determining a key parameter will now be described. Parameter determination unit 366 refers to parameter determination table 384 and sums up key points corresponding to the acquired event information, in the same manner as for the tempo parameter. The value of the sum of key points may be referred to as “the key point sum”.

As an example, it is assumed that the event “corner mode” occurs thirteen times and “operate in turbo mode” occurs thirteen times in a predetermined period of time. In this case, parameter determination unit 366 calculates that the key point sum is “0.52”.

Parameter determination unit 366 calculates one key parameter, based on a probability distribution (for example, Gaussian distribution) with the calculated value of the key point sum at the center. The parameter determination unit determines the key parameter by rounding off the calculated key parameter to the nearest integer.

As an example, it is assumed that parameter determination unit 366 calculates that the key parameter is “0.58” when the key point sum is “0.52”. In this case, parameter determination unit 366 determines that the key parameter is “1” by rounding off the calculated value to the nearest integer.

The point sum for determining a music parameter, such as the genre point sum, the tempo point sum, and the key point sum described above, may be collectively referred to as “history music parameter”. As described above, server 150 according to an embodiment calculates a history music parameter and stochastically determines a music parameter based on the calculated history music parameter. With this processing, the tendency of the generated music varies each time. Consequently, server 150 can prevent the user from being bored with the generated music.

(Flow of Control of Music Generation)

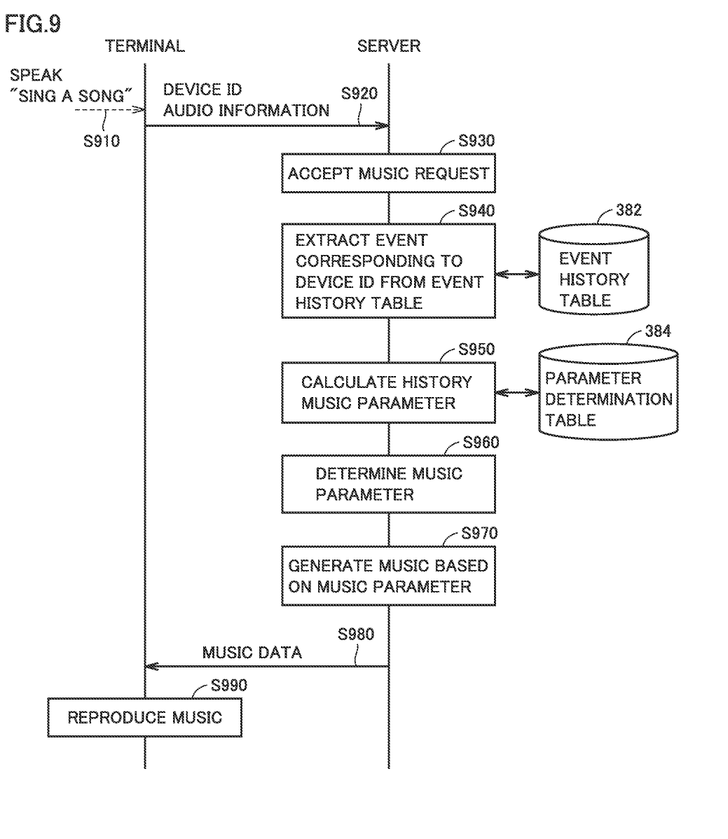

FIG. 9 is a flowchart illustrating the control for generating music according to an embodiment. The process shown in FIG. 6 is implemented by CPU 110 and CPU 360 executing the control programs held in the respective storage devices.

At step S910, the user says to microphone 335 of terminal 100 “Sing a song.”

At step S920, CPU 310 of terminal 100 transmits audio information input from microphone 335 and device ID 317 to server 150.

At step S930, CPU 360 of server 150 serves as speech recognition unit 364 and extracts the character string “Sing a song” from the received audio information. Speech recognition unit 364 determines that a predetermined character string (for example, “Sing”, “Can you sing me a song?”) is included in the extracted the character string. CPU 360 thus accepts a music request from terminal 100.

As an example, speech recognition unit 364 compares waveform data delimited by predetermined time units (for example, in units of 10 msec) from the head of the audio information with an acoustic model (the feature amount of sound for each phoneme such as vowel and consonant) stored in storage device 380 to extract a character string from the audio information. Here, speech recognition unit 364 may extract a character string from the audio information in accordance with HMM (Hidden Markov Model).

At step S940, CPU 360 serves as event information acquiring unit 362 and refers to event history table 382 to extract event information corresponding to device ID 317 received in a predetermined period of time.

At step S950, CPU 360 serves as parameter determination unit 366 and refers to parameter determination table 384 to calculate a history music parameter (genre point sum, tempo point sum, key point sum) based on the extracted event information.

At step S960, CPU 360 serves as parameter determination unit 366 and determines a music parameter (genre parameter, tempo parameter, key parameter) from the calculated history music parameter.

At step S970, CPU 360 serves as music generator 368 and generates music based on the determined music parameter.

At step S980, CPU 360 converts the generated music into music data that can be output from a sound output device and transmits the music data to terminal 100.

At step S990, terminal 100 outputs (reproduces) the received music data from speaker 330.

According to the foregoing, server 150 according to an embodiment generates music based on the history of terminal 100. The history of terminal 100 is updated as appropriate with time. Therefore, a plurality of pieces of music generated by server 150 may tend to vary according to the history of terminal 100 of the moment. This server device thus can prevent the user from being bored with the generated music.

When the user has a plurality of terminals 100 (for example, a vacuum cleaner and a refrigerator), server 150 according to an embodiment generates music according to the history of each terminal. Therefore, server 150 according to an embodiment can prevent the user from being bored with the generated music even when the user has a plurality of terminals 100.

### Second Embodiment—Method of Calculating Other Music Parameters (Device Type, User Setting)

In the foregoing embodiment, server 150 is configured to determine a music parameter only based on the history of terminal 100. In this embodiment, server 150 may determine a music parameter, considering other parameters in addition to the history of terminal 100.

(Relation Among Home, Terminal, and User)

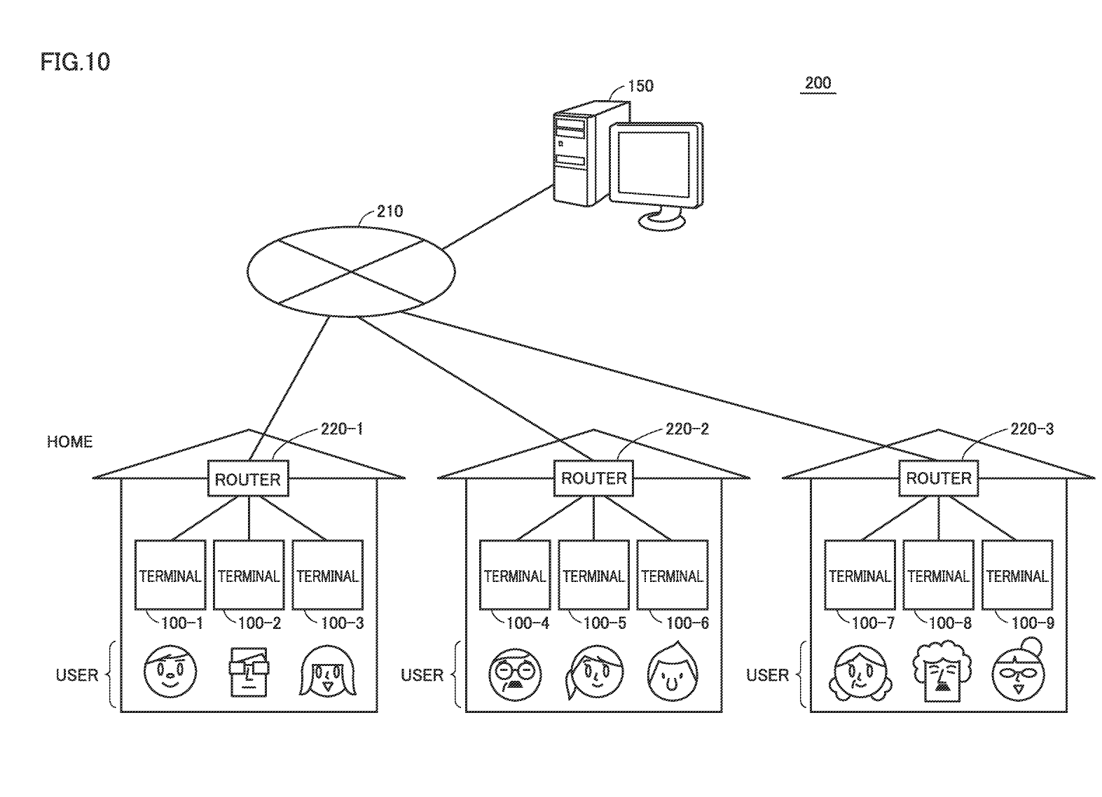

FIG. 10 is a diagram illustrating a control system 200 according to an embodiment in another aspect. Router 220 placed in each household is connected to a network 210. One or more terminals 100 are placed in each household. In each household, one or more users may operate terminal 100.

(Configuration of Terminal 100 and Server 150)

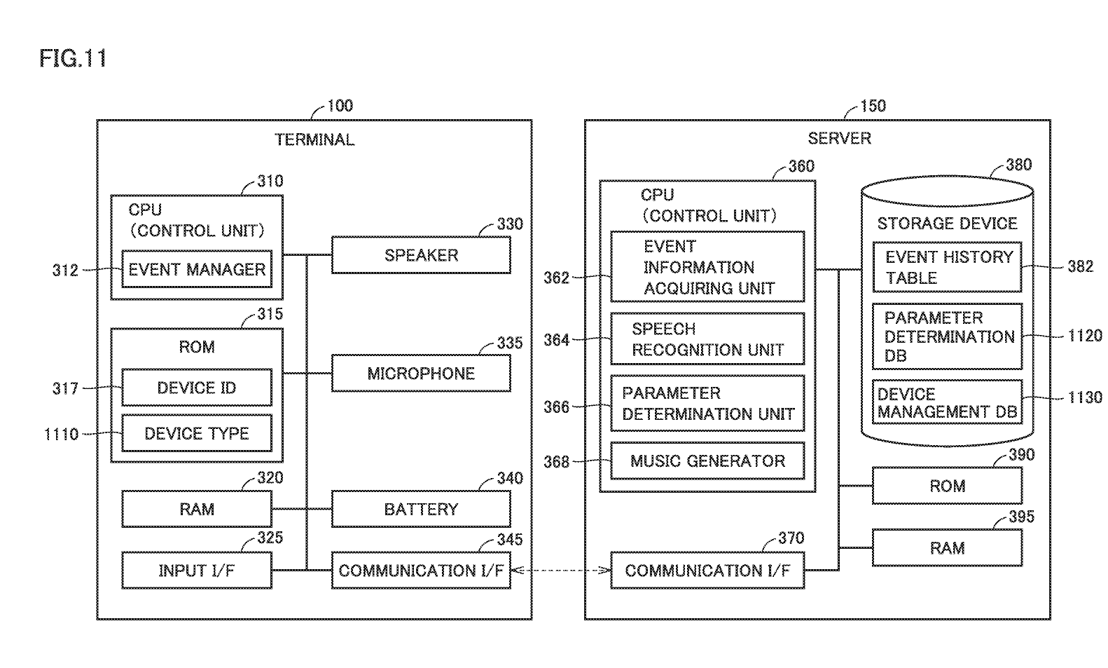

FIG. 11 is a diagram illustrating a configuration of terminal 100 and server 150 according to an embodiment. In the example shown in FIG. 11, the hardware configuration of terminal 100 and server 150 is the same as the hardware configuration of terminal 100 and server 150 illustrated in FIG. 3 and will not be further elaborated.

ROM 315 of terminal 100 shown in FIG. 11 differs from the ROM illustrated in FIG. 3 in that it further stores device type 1110 in addition to device ID 317.

In an aspect, device type 1110 may be information for specifying the type of terminal 100 (for example, vacuum cleaner, refrigerator, microwave oven, etc.). In another aspect, device type 1110 may be information for specifying the product name of terminal 100.

Storage device 380 shown in FIG. 11 differs from the storage device illustrated in FIG. 3 in that it stores a parameter determination DB 1120 in place of parameter determination table 384 and further stores a device management DB 1130.

(Device Management DB)

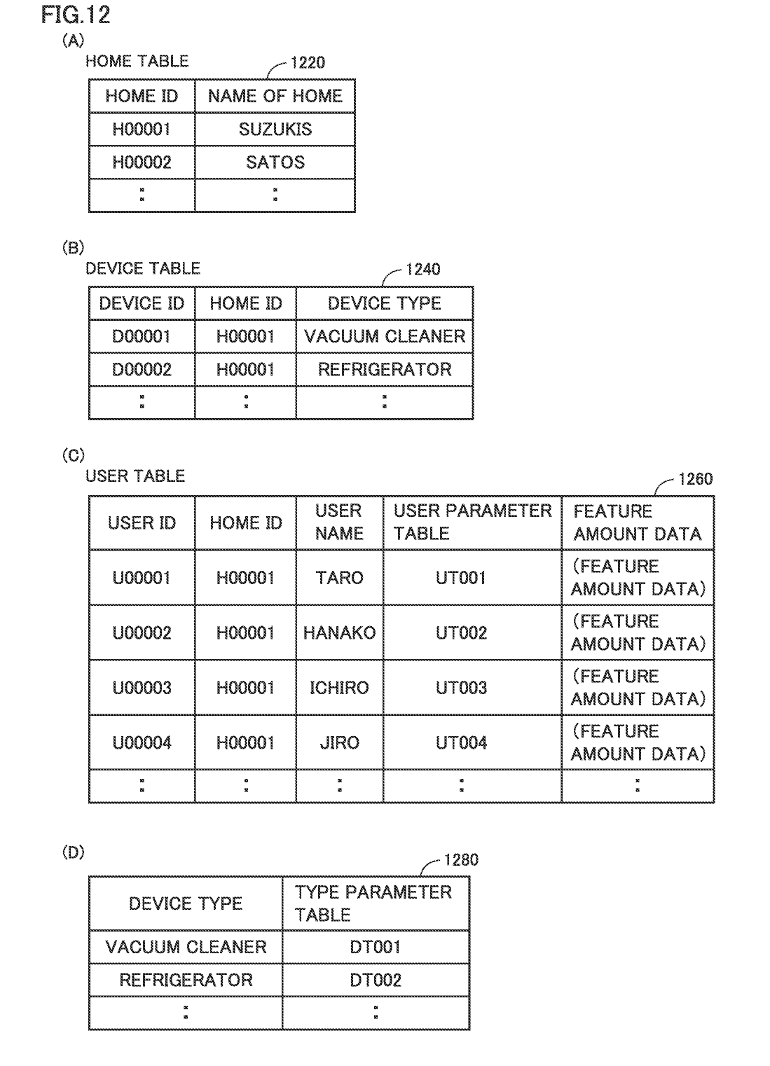

FIG. 12 is a diagram illustrating device management DB 1130 according to an embodiment.

In an embodiment, device management DB 1130 includes a home table 1220, a device table 1240, a user table 1260, and a device type table 1280.

Subfigure (A) is a diagram illustrating home table 1220 according to an embodiment.

Home table 1220 holds a home ID and the name of home associated with each other.

In an aspect, the home ID is information for identifying a household connected to server 150. In an aspect, the home ID may be a global IP address allocated to router 220.

In an aspect, the name of home may be the family name of people belonging to a household connected to server 150. The name of home may be registered by the user operating input I/F 325 or speaking to microphone 335.

Subfigure (B) is a diagram illustrating device table 1240 according to an embodiment.

Device table 1240 holds a device ID, a home ID, and a device type associated with each other.

In an aspect, server 150 receives a device ID, a home ID, and a device type from router 220. Server 150 may compare the received device ID with each of a plurality of device IDs held in device table 1240 and, if it is determined that there is no match for device ID, may register the received device ID, home ID, and device type in device table 1240 in association with each other.

Subfigure (C) is a diagram illustrating user table 1260 according to an embodiment. User table 1260 holds a user ID, a home ID, a user name, a user parameter table, and feature amount data associated with each other.

The user ID is information for identifying each of a plurality of users of terminal 100. The user name is the name for identifying the user of terminal 100 that is set by the user operating input I/F 325 or speaking to microphone 335.

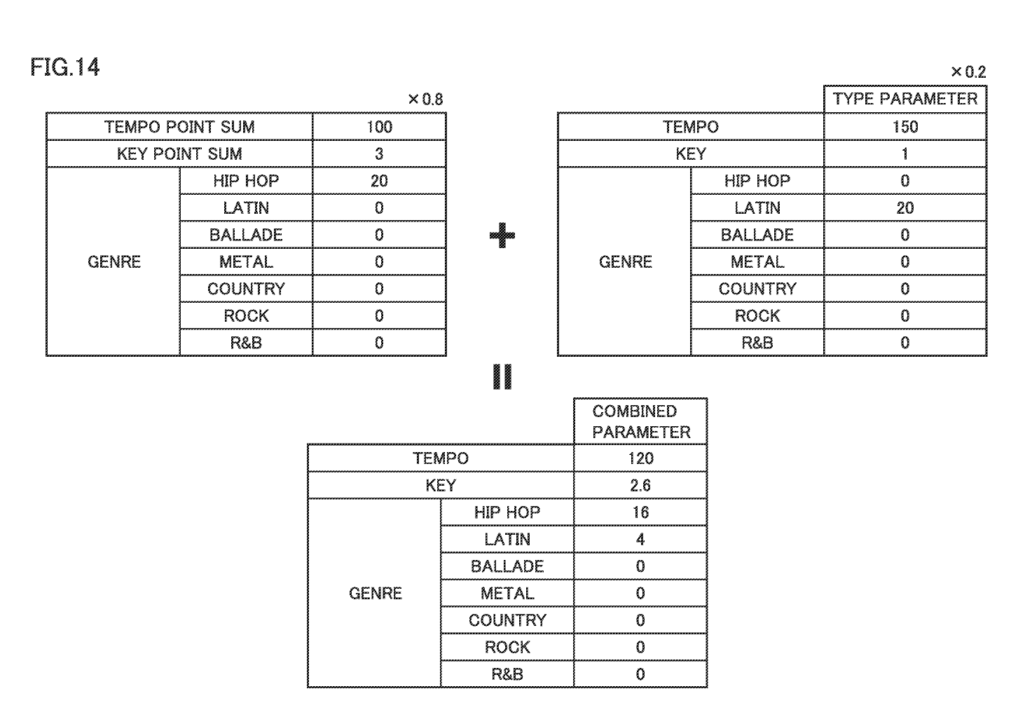

The user parameter table is a setting value for each user, used for calculation in determining a music parameter. The detail of this table will be described later with reference to FIG. 14.

The feature amount data is a feature extracted from audio information corresponding to the user's voice. The feature amount data may be calculated by a known method such as LPC (Linear Predictive Coding) cepstrum coefficient and MFCC (Mel-Frequency Cepstrum Coefficient).

Subfigure (D) is a diagram illustrating device type table 1280 according to an embodiment. Device type table 1280 holds a device type and a type parameter table associated with each other.

The type parameter table is a setting value for each device type, used for calculation in determining a music parameter.

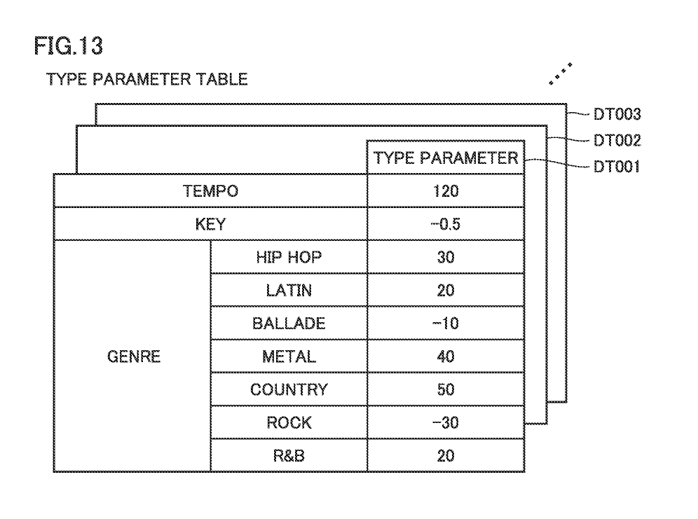

FIG. 13 is a diagram illustrating the type parameter table according to an embodiment.

Referring to FIG. 13, in the type parameter table, a type parameter is set for each of “genre” (each genre), “tempo”, and “key” described above.

In the example shown in FIG. 13, for type parameter table DT001 corresponding to the device type “vacuum cleaner”, the type parameter of tempo is set to “120”, the type parameter of key is set to “−0.5”, the type parameter of hip hop is set to “30”, the type parameter of hip hop is set to “20”, the type parameter of hip hop is set to “−10”, the type parameter of hip hop is set to “40”, the type parameter of hip hop is set to “50”, the type parameter of hip hop is set to “−30”, and the type parameter of hip hop is set to “20”.

In an aspect, CPU 360 of server 150 may serve as parameter determination unit 366 and determine a music parameter based on the history music parameter and the type parameter.

FIG. 14 is a diagram illustrating the control of determining a music parameter based on the history music parameter and the type parameter according to an embodiment.

In the example shown in FIG. 14, it is calculated that the tempo point sum is “100”, the key point sum is “3”, the genre point sum of hip hop is “20”, and the genre point sum of other genres is “0”.

It is also calculated that the type parameter of tempo is “150”, the type parameter of key is “1”, the type parameter of Latin is “20”, and the type parameter of other genres is “0”.

In an aspect, parameter determination unit 366 calculates the combined parameter by combining the value obtained by multiplying the history music parameter by a coefficient 0.8 and the value obtained by multiplying the type parameter by a coefficient 0.2. In another aspect, the user may set the value of each coefficient as desired. It is noted that the value of each coefficient is set such that the total value of the coefficients is 1.0.

In the example shown in FIG. 14, parameter determination unit 366 calculates that the combined parameter of tempo is “120” (=100×0.8+150×0.2), the combined parameter of key is “2.6”, the combined parameter of hip hop is “16”, the combined parameter of Latin is “4”, and the combined parameter of other genres is “0”.

Parameter determination unit 366 performs control similar to the control illustrated in FIG. 8 above, based on the calculated combined parameter, to determine a music parameter.

According to the foregoing, server 150 according to an embodiment determines a music parameter considering the type parameter set according to the device type. With server 150, music reproduced in a plurality of terminals tends to vary when the user has different types of terminals 100. Consequently, server 150 can prevent the user from being bored with the generated music even when the user has different types of terminals 100.

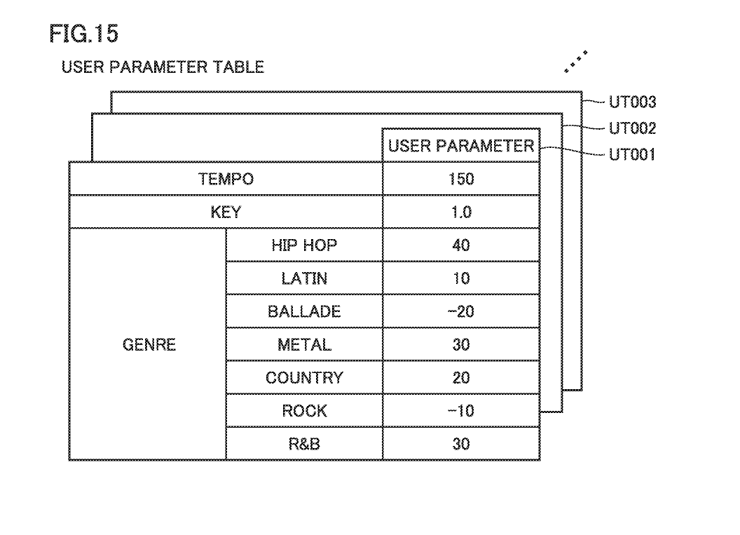

FIG. 15 is a diagram illustrating the user parameter table according to an embodiment.

Referring to FIG. 15, in the user parameter table, a user parameter is set for each of “genre” (each genre), “tempo”, and “key” described above.

In the example shown in FIG. 15, for user parameter table UT001 corresponding to user ID “U00001”, the user parameter of tempo is set to “150”, the user parameter of key is set to “1.0”, the user parameter of hip hop is set to “40”, the user parameter of hip hop is set to “10”, the user parameter of hip hop is set to “−20”, the user parameter of hip hop is set to “30”, the user parameter of hip hop is set to “20”, the user parameter of hip hop is set to “−10”, and the user parameter of hip hop is set to “30”.

In an aspect, the user may input a user parameter to terminal 100 by operating input I/F 325 or speaking to microphone 335. Terminal 100 transmits the input user parameter and device ID 317 to server 150. Server 150 stores the received device ID 317 and the user parameter table into user table 1260 in association with each other.

In an aspect, CPU 360 of server 150 may serve as parameter determination unit 366 and determine a music parameter based on the history music parameter and the user parameter. In yet another aspect, parameter determination unit 366 may determine a music parameter based on the history music parameter, the type parameter, and the user parameter. The method of determining a music parameter using these parameters is the same as the method illustrated in FIG. 14 and will not be further elaborated. The value of the coefficient with which each parameter is multiplied may be changed as appropriate by the user.

According to the foregoing, server 150 according to an embodiment determines a music parameter considering the user parameter, in other words, considering the user's preference. Server 150 thus may generate music preferred by the user, based on the history of terminal 100.

(Flow of Control of Music Generation)

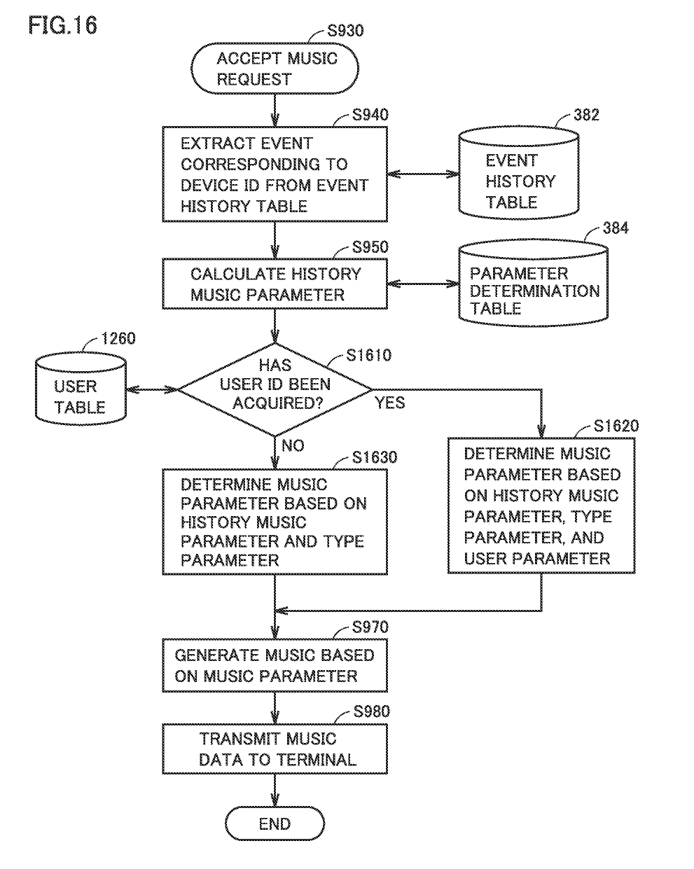

FIG. 16 is a flowchart illustrating the control in server 150 for generating music according to an embodiment. The process shown in FIG. 6 is implemented by CPU 360 executing the control program stored in storage device 380 or ROM 390. The parts denoted by the same reference signs as in FIG. 9 refer to the same processes and a description of these parts will not be repeated. The control shown in FIG. 16 may be performed in response to the process of accepting a music request at step S930 in FIG. 9.

At step S1610, CPU 360 determines whether a user ID has been acquired from audio information received from terminal 100.

More specifically, CPU 360 calculates a feature amount from the received audio information. CPU 360 then compares the calculated feature amount with each of a plurality of feature amounts stored in user table 1260 and calculates the degree of matching for the feature amount of each user. CPU 360 then determines whether there exists the feature amount of a user having a degree of matching greater than a predetermined value. If there exists, CPU 360 acquires the user ID corresponding to the feature amount of the user. If there exist a plurality of feature amounts of users having a degree of matching greater than a predetermined value, CPU 360 acquires the user ID corresponding to the feature amount with the largest degree of matching.

If the user ID has been acquired (YES at step S1610), CPU 360 proceeds to step S1620. If not (NO at step S1610), CPU 360 proceeds to step S1630.

At step S1620, CPU 360 determines a music parameter based on the history music parameter calculated at step S950, the type parameter, and the user parameter.

More specifically, CPU 360 refers to device table 1240 to acquire a device type corresponding to the received device ID 317 and refers to device type table 1280 to acquire a type parameter from the type parameter table corresponding to the acquired device type.

CPU 360 refers to user table 1260 to acquire a user parameter from the user parameter table corresponding to the user ID acquired at step S1610.

At step S1630, CPU 360 determines a music parameter based on the history music parameter and the type parameter.

At step S970, CPU 360 serves as music generator 368 and generates music based on the determined music parameter.

### Third Embodiment—Music Generation by Terminal

In the foregoing embodiments, terminal 100 is configured to transmit event information to server 150 and receive music data from server 150. However, receiving music data from the server may be difficult in some cases, for example, when the network environment is bad. Then, a terminal according to an embodiment is configured to generate music data by itself.

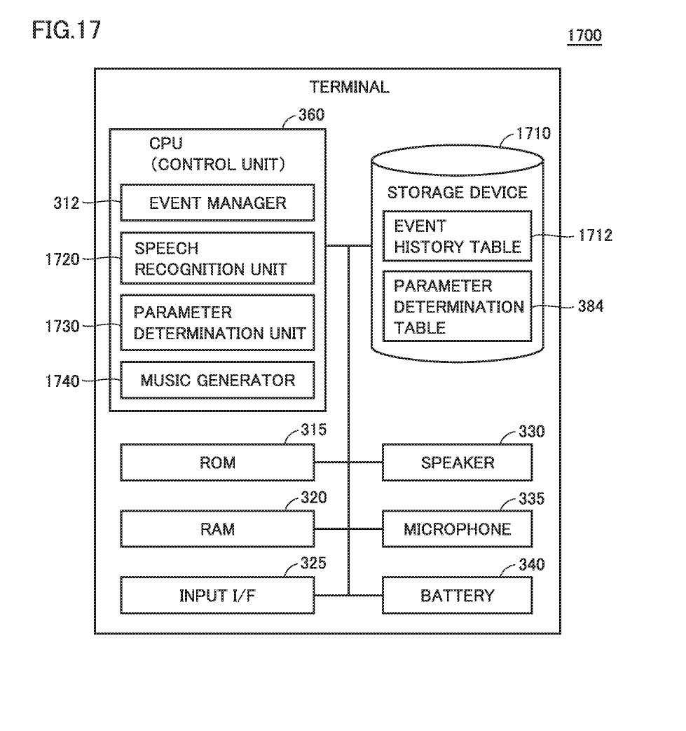

FIG. 17 is a diagram illustrating a configuration example of a terminal 1700 according to an embodiment. The parts denoted by the same reference signs as in FIG. 3 are the same and a description of these parts will not be repeated.

Terminal 1700 differs from the hardware configuration of terminal 100 illustrated in FIG. 3 in that it has a storage device 1710 and does not have communication I/F 345.

CPU 310 of terminal 1700 may further function as a speech recognition unit 1720, a parameter determination unit 1730, and a music generator 1740, in addition to event manager 312, by reading and executing a control program stored in ROM 315 or storage device 1710. Speech recognition unit 1720, parameter determination unit 1730, and music generator 1740 have the same functions as speech recognition unit 364, parameter determination unit 366, and music generator 368, respectively, illustrated in FIG. 3.

Storage device 1710 includes an event history table 1712 and a parameter determination table 384. Event history table 1712 is a table that holds a time and an event associated with each other, in event history table 382 illustrated in FIG. 5, and is not illustrated.

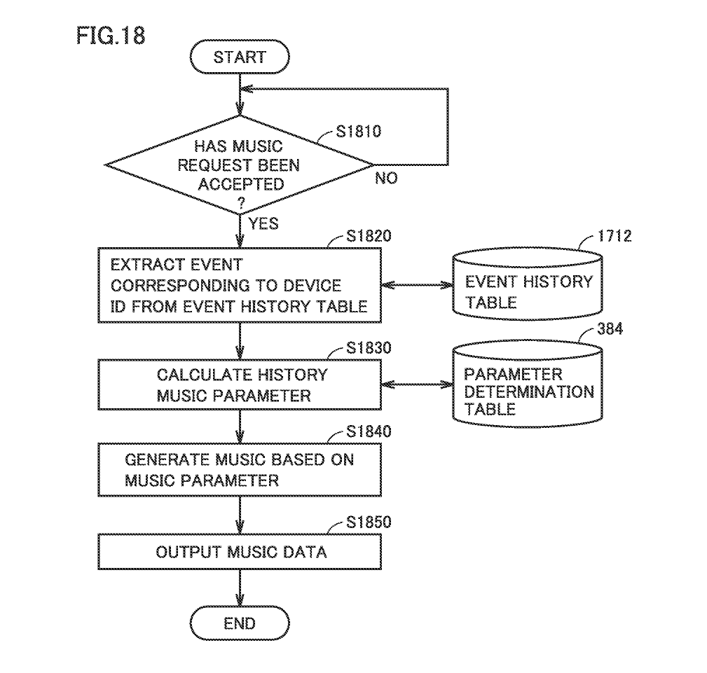

FIG. 18 is a flowchart illustrating the control of generating music in terminal 1700 according to an embodiment. The process shown in FIG. 18 may be performed by CPU 310 of terminal 1700 reading and executing a control program stored in ROM 315 or storage device 1710.

At step S1810, CPU 310 serves as speech recognition unit 1720 and determines whether a music request has been accepted. This process is substantially the same as the process at step S930 described above.

At step S1820, CPU 310 serves as event manager 312 and refers to event history table 1712 to extract event information in a predetermined period of time (for example, 90 days).

At step S1830, CPU 310 serves as parameter determination unit 1730 and refers to parameter determination table 384 to calculate a history music parameter based on the extracted event information.

At step S1840, CPU 310 serves as parameter determination unit 1730 and determines a music parameter from the calculated history music parameter. In the same step, CPU 310 serves as music generator 1740 and generates music based on the determined music parameter.

At step S1850, CPU 310 converts the generated music into music data that can be output from a sound output device and outputs (reproduces) music from speaker 330.

According to the foregoing, terminal 1700 according to an embodiment can generate music based on the history of the terminal itself even in an offline environment, independently of the server.

The controls described above are implemented by one CPU 310 or one CPU 360. However, embodiments are not limited to this configuration. The controls may be implemented by a semiconductor integrated circuit such as at least one processor.

The circuit may implement the controls described above by reading one or more instructions from at least one tangible and readable medium.

Such a medium is in the form of memory of any type, such as magnetic medium (for example, hard disc), optical medium (for example, compact disc (CD), DVD), volatile memory, and nonvolatile memory. However, embodiments are not limited to such forms.

The volatile memory may include DRAM and SRAM (Static Random Access Memory). The nonvolatile memory may include ROM and NVRAM. The semiconductor memory may be part of a semiconductor circuit together with at least one processor.

The embodiments disclosed here should be understood as being illustrative rather than being limitative in all respects. The scope of the present invention is shown not in the foregoing description but in the claims, and it is intended that all modifications that come within the meaning and range of equivalence to the claims are embraced here.

### REFERENCE SIGNS LIST

100, 1700 terminal, 150 server, 200 control system, 210 network, 220 router, 312 event manager, 315, 390 ROM, 320, 395 RAM, 330 speaker, 335 microphone, 340 battery, 362 event information acquiring unit, 364, 1720 speech recognition unit, 366, 1730 parameter determination unit, 368, 410, 1740 music generator, 380, 1710 storage device, 382, 1712 event history table, 384 parameter determination table, 400 external device, 1110 device type, 1220 home table, 1240 device table, 1260 user table, 1280 device type table.

1. A server device comprising:
a communication interface;
a storage device; and
a control device, wherein
the storage device stores a state history of an information processing terminal capable of outputting sound, the state history being acquired through the communication interface, and
the control device is configured to
determine a music parameter based on the state history and
transmit music generated based on the determined music parameter to the information processing terminal through the communication interface.

2. The server device according to claim 1, wherein
the control device includes a music generator for generating music based on the music parameter, and
the control device is configured to transmit music generated by the music generator to the information processing terminal.

3. The server device according to claim 1, wherein
the control device is configured to
transmit the determined music parameter to an external device configured to generate music based on a music parameter and
transmit the music received from the external device to the information processing terminal.

4. The server device according to claim 1, wherein
the communication interface is configured to communicate with different types of information processing terminals,
the storage device is configured to further store a type parameter for each of the types, and
the control device is configured to determine the music parameter, based on a type parameter corresponding to the type of one information processing terminal of the different types of information processing terminals and a state history of the one information processing terminal.

5. The server device according to claim 1, wherein
the storage device is configured to further store a user parameter set for each user of the information processing terminal, and
the control device is configured to determine the music parameter based on the user parameter and the state history.

6. The server device according to claim 1, wherein the control device is configured to determine the music parameter based on the state history in a predetermined period of time.

7. The server device according to claim 1, wherein the music parameter includes at least one of: a tempo parameter for determining a tempo of music; a genre parameter for determining a genre of music; and a key parameter for determining a key of music.

8. The server device according to claim 1, wherein the control device is configured to calculate a history music parameter based on the state history and determine the music parameter based on a probability corresponding to the calculated history music parameter.

9. An information processing terminal comprising:
a sound output device;
a communication interface; and
a control device configured to transmit event information of the information processing terminal to a server device through the communication interface, wherein
the server device is configured to
determine a music parameter based on a history of the event information and
transmit music generated based on the determined music parameter to the information processing terminal, and
the control device is configured to output the music received from the server device through the communication interface from the sound output device.

10. A system comprising a server device and an information processing terminal,
the server device including
a communication interface,
a storage device, and
a control device, wherein
the storage device stores a state history of the information processing terminal, and
the control device is configured to
determine a music parameter based on the state history and
transmit music generated based on the determined music parameter to the information processing terminal through the communication interface,
the information processing terminal including
a sound output device and
a control device configured to output the music received from the server device from the sound output device.

11. A method for a server device to transmit music to an information processing terminal capable of outputting sound, the method comprising:
receiving event information from the information processing terminal;
determining a music parameter based on a history of the event information; and
transmitting music generated based on the determined music parameter to the information processing terminal.
